(19) United States
(12) Patent Application Publication
(10) Pub. No.: US 2017/0021619 A1
(43) Pub. Date: Jan. 26, 2017

(54) LIQUID EJECTION HEAD

(71) Applicant: CANON KABUSHIKI KAISHA, Tokyo (JP)

(72) Inventor: Takuma Kodoi, Kawasaki-shi (JP)

(21) Appl. No.: 15/196,319

(22) Filed: Jun. 29, 2016

(30) Foreign Application Priority Data
Jul. 24, 2015 (JP) 2015-146458

(51) Int. Cl. B41J 2/14

(52) U.S. Cl. CPC B41J 2/1433

(57) ABSTRACT

Provided is a liquid ejection head, including: a liquid chamber; a supply port; and a recording element substrate arranged at a position opposed to the supply port across the liquid chamber. The liquid chamber includes: a first surface connected to the supply port; and a wall surface extending in a direction away from the recording element substrate. The wall surface includes: a space chamber connected to the first surface; and a second surface connecting a wall surface of the space chamber and the recording element substrate to each other. An intersection portion of the wall surface of the space chamber and a plane extended from the first surface is more distant from the recording element substrate than a connection portion between the wall surface of the space chamber and the second surface.

### BACKGROUND OF THE INVENTION

Field of the Invention

The present invention relates to a liquid ejection head configured to eject liquid.

Description of the Related Art

In general, in a liquid ejection head configured to eject liquid to perform recording or other operation, a recording element substrate including an ejection orifice array, which is configured to eject the liquid, is mounted onto a support member. The support member has a liquid chamber configured to temporarily store the liquid therein and a flow path connecting the liquid chamber to the ejection orifice array.

In recent years, in the above-mentioned liquid ejection head, a length of the ejection orifice array has been increased in order to achieve high-speed recording and the like. When the length of the ejection orifice array has been increased, a large amount of liquid may be ejected from the ejection orifice array at one time. Thus, the liquid may abruptly flow in the liquid chamber and the like. In this case, meniscus vibration of the liquid is intensified near the ejection orifices. As a result, there arises a problem in that the liquid in the liquid chamber is vibrated, and then causing a printing failure.

In this context, in a liquid ejection recording head disclosed in Japanese Patent Application Laid-Open No. 2006-240150, a buffer chamber, being a space chamber configured to accumulate air bubbles therein, is formed in a liquid chamber. Vibration of the liquid in the liquid chamber is suppressed through expansion and contraction of the air bubbles accumulated in the buffer chamber.

However, in the liquid ejection recording head described in Japanese Patent Application Laid-Open No. 2006-240150, gas dissolved in the liquid is transformed into the air bubbles, and then is combined with the air bubbles accumulated in the buffer chamber. As a result, the air bubbles accumulated in the buffer chamber may be increased. In this case, the air bubbles may reach the ejection orifices to cause ejection failure.

### SUMMARY OF THE INVENTION

The present invention has been made in view of the above-mentioned problem, and has an object to provide a liquid ejection head capable of preventing ejection failure caused by air bubbles.

According to one embodiment of the present invention, there is provided a first liquid ejection head, including:
a liquid chamber configured to store liquid therein;
a supply port configured to supply the liquid into the liquid chamber; and
a recording element substrate, which is arranged at a position opposed to the supply port across the liquid chamber, and is configured to eject the liquid stored in the liquid chamber,
in which the liquid chamber includes:
   a first surface connected to the supply port; and
   a wall surface extending in a direction away from the recording element substrate,
in which the wall surface includes:
   a space chamber connected to the first surface; and
   a second surface connecting a wall surface of the space chamber and the recording element substrate to each other, and
in which an intersection portion of the wall surface of the space chamber and a plane extended from the first surface is more distant from the recording element substrate than a connection portion between the wall surface of the space chamber and the second surface.

Further, according to one embodiment of the present invention, there is provided a second liquid ejection head, including:
a recording element substrate having ejection orifices configured to eject liquid; and
a support member configured to support the recording element substrate,
in which the support member includes:
   a liquid chamber configured to store therein the liquid to be supplied to the recording element substrate;
   a supply port configured to supply the liquid into the liquid chamber;
   a buffer chamber, which is formed in the liquid chamber on an opposite side to a side on which the recording element substrate is arranged, and is configured to accumulate air bubbles therein; and
   a connection surface connecting the supply port and the buffer chamber to each other, and
in which a plane extended from the connection surface intersects an inner wall surface of the buffer chamber.

Further features of the present invention will become apparent from the following description of exemplary embodiments with reference to the attached drawings.

### BRIEF DESCRIPTION OF THE DRAWINGS

FIG. 1 is a perspective view for illustrating an inkjet recording head according to a first embodiment of the present invention.

FIG. 2 is a sectional view of the inkjet recording head of FIG. 1 taken along the line A-A.

FIG. 3A, FIG. 3B, FIG. 3C, and FIG. 3D are views for illustrating an example of actions of the inkjet recording head.

FIG. 4A and FIG. 4B are views for illustrating another example of actions of the inkjet recording head.

FIG. 5 is a sectional view for illustrating an inkjet recording head according to a comparative example of the first embodiment of the present invention.

FIG. 6 is a sectional view for illustrating an inkjet recording head according to a second embodiment of the present invention.

FIG. 7 is a sectional view for illustrating an inkjet recording head according to a comparative example of the second embodiment of the present invention.

FIG. 8 is a sectional view for illustrating an inkjet recording head according to a third embodiment of the present invention.

FIG. 9 is a sectional view for illustrating an inkjet recording head according to a fourth embodiment of the present invention.

FIG. 10 is a sectional view for illustrating an inkjet recording head according to a fifth embodiment of the present invention.

FIG. 11 is a transparent perspective view for illustrating the inkjet recording head according to the fifth embodiment of the present invention.

### DESCRIPTION OF THE EMBODIMENTS

Now, embodiments of the present invention are described with reference to the attached drawings. Components that have the same functions are denoted by the same reference symbols throughout the drawings, and repetitive descriptions thereof may be omitted.

### First Embodiment

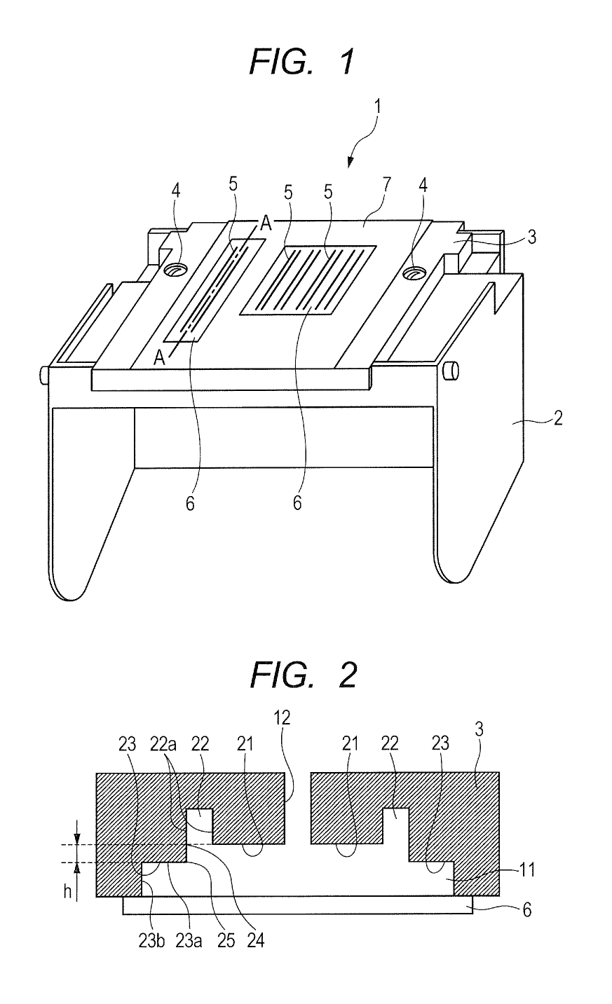

FIG. 1 is a perspective view for illustrating an inkjet recording head being a liquid ejection head according to a first embodiment of the present invention. As illustrated in FIG. 1, an inkjet recording head 1 according to this embodiment includes a casing 2 and a support member 3 mounted onto the casing 2. The casing 2 is made of, for example, a resin. In the example illustrated in FIG. 1, the support member 3 is fixed to the casing 2 with screws 4. The support member 3 supports a recording element substrate 6 including a plurality of ejection orifice arrays 5 each formed by arrayed ejection orifices configured to eject liquid. Further, an electric wiring substrate 7 configured to supply an electric signal such as a control signal to the recording element substrate 6 is mounted onto the support member 3.

FIG. 2 is a sectional view of the inkjet recording head 1 of FIG. 1 taken along the line A-A. However, in FIG. 2, the sectional view is inverted from FIG. 1. As illustrated in FIG. 2, the support member 3 of the inkjet recording head 1 includes a liquid chamber 11 configured to store liquid therein (more specifically, temporarily store liquid therein), and a supply port 12 configured to supply the liquid into the liquid chamber 11. The recording element substrate 6 is arranged at a position opposed to the supply port 12 across the liquid chamber 11. In the example illustrated in FIG. 2, the supply port 12 extends in a direction substantially perpendicular to the recording element substrate 6.

The liquid chamber 11 includes a first surface 21 connected to the supply port 12, buffer chambers 22 each connected to the first surface 21, and a second surface 23 connected to the buffer chambers 22 and the recording element substrate 6. Accordingly, the first surface 21 is a connection surface connecting the supply port 12 and the buffer chambers 22 to each other.

The first surface 21 is substantially parallel to the recording element substrate 6.

Each of the buffer chambers 22 is formed in the liquid chamber 11 on an opposite side to a side on which the recording element substrate 6 is arranged. Each of the buffer chambers 22 is a space chamber including a wall surface 22a being an inner wall surface extending in a direction away from the recording element substrate 6, and accumulates air bubbles inside as described later. In this embodiment, the wall surface 22a of each of the buffer chambers 22 extends substantially perpendicularly to the recording element substrate 6. Further, one buffer chamber is formed on each side of the support member 3 with respect to the supply port 12, but the buffer chamber 22 may be formed on only one of both sides of the support member 3 with respect to the supply port 12.

The second surface 23 includes a first portion 23a extending substantially in parallel to the recording element substrate 6 from a connection portion 25 between the wall surface 22a of each of the buffer chambers 22 and the second surface 23, and a second portion 23b extending toward the first portion 23a from a connection portion between the recording element substrate 6 and the second surface 23. In this embodiment, the second portion 23b is substantially perpendicular to the recording element substrate 6.

Further, an intersection portion 24 of the wall surface 22a of each buffer chamber 22 and a plane extended from the first surface 21 is more distant from the recording element substrate 6 than the connection portion 25 between the buffer chamber 22 and the second surface 23. The wall surface 22a of the buffer chamber 22 includes a first portion on the supply port side, and a second portion on an opposite side to the first portion. The plane extended from the first surface 21 intersects the second portion. In this embodiment, h represents a difference between a distance from the intersection portion 24 to the recording element substrate 6, and a distance from the connection portion 25 to the recording element substrate 6. Note that, each buffer chamber 22 described in this embodiment corresponds to a region surrounded by the wall surface 22a of the buffer chamber 22, specifically, a deep region behind an opening plane that connects the connection portion between the wall surface 22a and the first surface 21 to the connection portion between the wall surface 22a and the second surface 23.

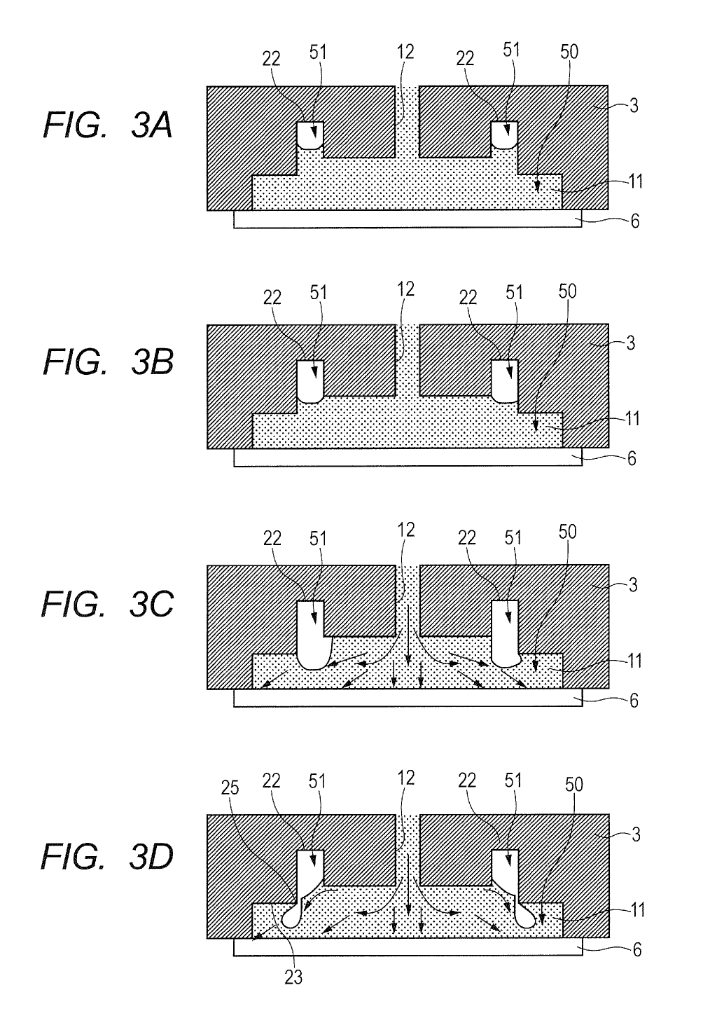

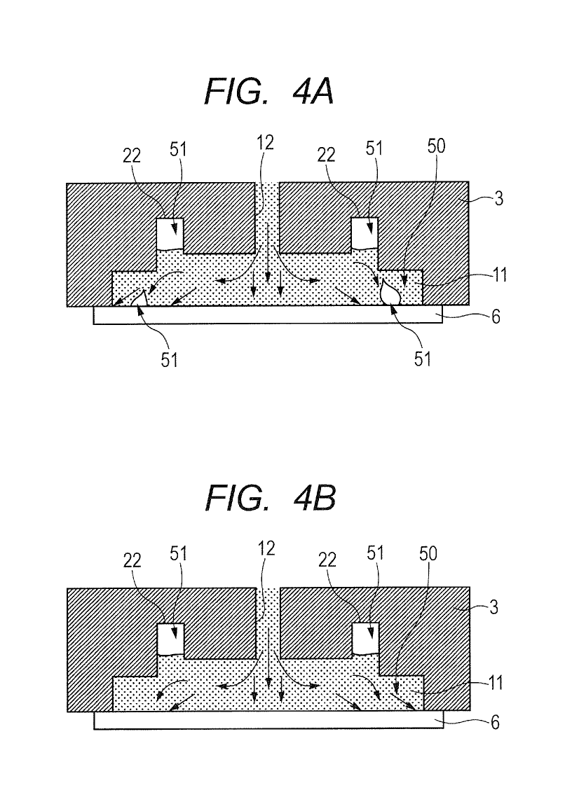

FIGS. 3A to 3D and FIGS. 4A and 4B are views for illustrating actions of the inkjet recording head 1 when liquid is ejected from the recording element substrate 6.

First, as illustrated in FIG. 3A, liquid 50 is supplied from the supply port 12 into the liquid chamber 11, and the liquid 50 is filled into the liquid chamber 11. At this time, a most part of the air in the liquid chamber 11 is discharged to an outside from the ejection orifices of the recording element substrate 6, but a part of the air in the liquid chamber 11 remains in the buffer chambers 22 as air bubbles 51. At this time, the air bubbles 51 accumulate to such an extent that the air bubbles 51 do not overflow from the buffer chambers 22.

The liquid 50 filled into the liquid chamber 11 is filled into a large number of pressure chambers (not shown) in the recording element substrate 6, and heating resistance elements corresponding to the respective pressure chambers are selectively driven. Thus, the liquid 50 is ejected from the ejection orifices of the recording element substrate 6. In this embodiment, one thousand two hundred and eighty ejection orifices each configured to eject a liquid droplet of 12 pl are arranged at a density of 1,200 dpi, and a maximum ejection frequency of each of the ejection orifices is 24 kHz. Therefore, when ejecting the liquid droplets from all of the ejection orifices, the inkjet recording head 1 can eject the liquid at a flow rate of 22 ml/min.

When the large amount of liquid is ejected at one time as described above, the liquid in the liquid chamber 11 may be vibrated. However, in the inkjet recording head according to this embodiment, the vibration can be buffered through expansion and contraction of the air bubbles 51 accumulated in the buffer chambers 22. Further, the buffer chambers 22 are arranged near the recording element substrate 6, thereby being capable of also coping with vibration caused by a sudden change in negative pressure in the liquid chamber 11 when the liquid droplets are ejected at high frequency.

In this embodiment, the ejection orifices are kept at, for example, 40° C. before recording operation. In order to easily keep the ejection orifices warm, the support member 3 is made of a resin having a relatively small heat capacity. However, the support member 3 may be made of a material such as metal, which is different from the resin. Regardless of whether the support member 3 is made of the resin or the metal, the above-mentioned problem may arise due to the vibration. Accordingly, the buffer chambers 22 are useful.

When recovery operation or the like for maintaining the ejection operation and the ejection function described above is repeatedly performed, as illustrated in FIG. 3B, the air bubbles 51 in each buffer chamber 22 are increased by, for example, gas dissolved in the liquid. Then, as illustrated in FIG. 3C, the air bubbles 51 exceed a volume of the buffer chamber 22, and increase to overflow from the buffer chamber 22. Under such a circumstance, as illustrated in FIG. 3D, by a flow of the liquid 50 indicated by the arrows of FIG. 3D, a part of the air bubbles 51 is pushed against the connection portion 25 between the second surface and the buffer chamber 22, and then separated by the connection portion 25. Further, as illustrated in FIG. 4A, one separated part of the air bubbles 51 remains in the buffer chamber 22, whereas another separated part thereof is caused to flow toward the recording element substrate 6, thereby being discharged from the ejection orifices of the recording element substrate 6 to the outside. In this manner, as illustrated in FIG. 4B, the air bubbles 51 are returned to an initial state of accumulating to such an extent that the air bubbles 51 do not overflow from the buffer chamber 22.

FIG. 5 is a sectional view for illustrating an inkjet recording head 1 according to a comparative example of this embodiment. In a liquid chamber 111 according to the comparative example illustrated in FIG. 5, an intersection portion 124 of a wall surface 122a of each buffer chamber 122 and a plane extended from a first surface 121, and a connection portion 125 between the wall surface 122a of the buffer chamber 122 and a second surface 123 conform to each other. Accordingly, the intersection portion 124 and the connection portion 125 are arranged at the same distance from a recording element substrate 106. In this case, even when the air bubbles increase to overflow from the buffer chamber 122, the connection portion 125 does not have a function of separating the air bubbles, with the result that the air bubbles continue increasing. Consequently, the air bubbles may reach the ejection orifices to cause the ejection failure.

In contrast, in the inkjet recording head 1 according to this embodiment, the intersection portion 24 is more distant from the recording element substrate 6 than the connection portion 25, thereby obtaining a configuration in which the connection portion 25 protrudes toward the liquid chamber 11. Thus, of the liquid supplied from the supply port 12 into the liquid chamber 11, a part of the liquid flowing along the first surface can push the air bubbles, which overflow from each of the buffer chambers 22, against the connection portion 25, to thereby separate the air bubbles. Therefore, the air bubbles can be prevented from becoming overly larger than necessary. As a result, it is possible to prevent the ejection failure caused by the air bubbles.

Further, in this embodiment, the first portion 23a of the second surface 23 is substantially parallel to the recording element substrate 6. Thus, the connection portion 25 between the wall surface 22a of the buffer chamber 22 and the second surface 23 is formed as a substantially right-angled corner portion. This is preferred in view of ejection performance of how satisfactorily the ejection is performed. In this case, the description “substantially parallel” means that, for example, an angle formed by the first surface 21 and the recording element substrate 6 is about 5° or less, and the description “substantially right-angled” means that the corner portion has an angle of 90°±5°.

When the connection portion 25 is formed as an obtuse-angled corner portion, that is, when the second surface 23 is inclined so as to approach the recording element substrate 6 as extending away from the supply port in a direction parallel to the recording element substrate 6, the corner portion has low sharpness, thereby degrading air-bubble separability of how satisfactorily the air bubbles are separated.

Further, when the connection portion 25 is formed as an acute-angled corner portion, that is, when the first portion 23a of the second surface 23 is inclined so as to be distant from the recording element substrate 6 as extending away from the supply port 12 in the direction parallel to the recording element substrate 6, the corner portion has high sharpness, thereby enhancing the air-bubble separability. However, when the second surface 23 is inclined as described above, in addition to the buffer chambers 22, a space extending in the direction away from the recording element substrate 6 is defined in the vicinity of each connection portion between the first portion 23a and the second portion 23b of the second surface 23. Accordingly, the separated air bubbles enter the space, thereby degrading air-bubble dischargeability of how satisfactorily the air bubbles are discharged.

Therefore, a relationship between a shape of the connection portion 25 and the ejection performance is shown in Table 1.

TABLE 1

| Angle of connection portion | Air-bubble | Air-bubble | Ejection |
|---|---|---|---|
| (corner portion) | separability | dischargeability | performance |
| Acute angle | A | C | B |
| Right angle (90° ± 5°) | B | B | A |
| Obtuse angle | C | A | B |

Note that, the air-bubble separability, the air-bubble dischargeability, and the ejection performance are rated by A, B, C in a descending order of excellence.

### Second Embodiment

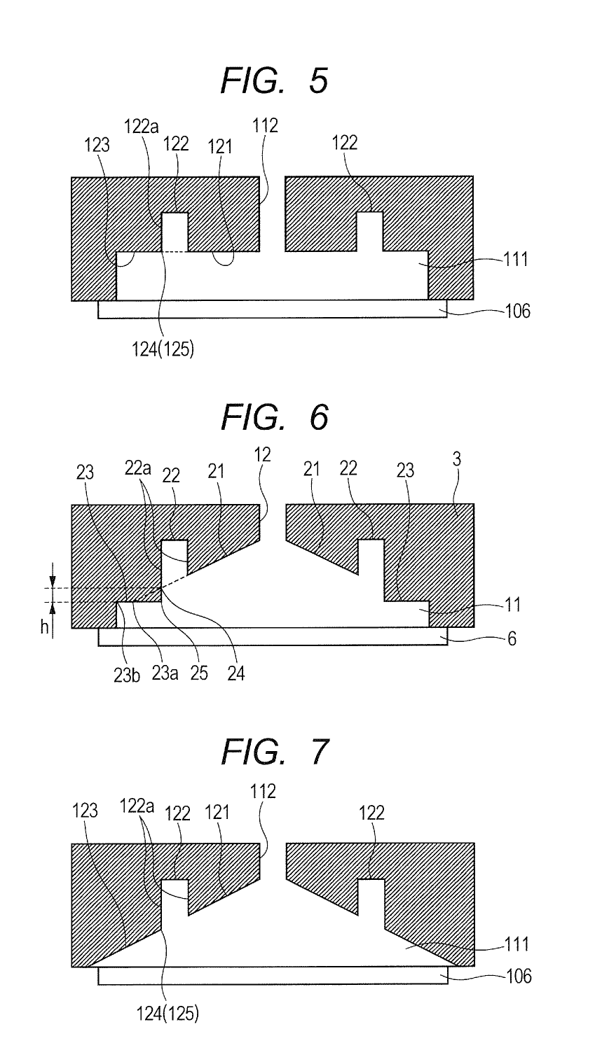

FIG. 6 is a view for illustrating an inkjet recording head 1 according to a second embodiment of the present invention. Similarly to FIG. 2, FIG. 6 is a sectional view of the inkjet recording head 1 of FIG. 1 taken along the line A-A.

As illustrated in FIG. 6, this embodiment is different from the first embodiment in that the first surface of the liquid chamber 11 is inclined so as to approach the recording element substrate 6 as extending away from the supply port 12 in the direction parallel to the recording element substrate 6.

Also in this embodiment, similarly to the first embodiment, the intersection portion 24 of the wall surface 22a of each buffer chamber 22 and the plane extended from the first surface 21 is more distant from the recording element substrate 6 than the connection portion 25 between the wall surface 22a of the buffer chamber 22 and the second surface 23. Accordingly, similarly to the first embodiment, it is possible to prevent the ejection failure caused by the air bubbles.

FIG. 7 is a sectional view for illustrating a liquid chamber of an inkjet recording head 1 according to a comparative example of this embodiment. In a liquid chamber 111 according to the comparative example illustrated in FIG. 7, the intersection portion 124 of the wall surface 122a of each buffer chamber 122 and the plane extended from the first surface 121, and the connection portion 125 between the wall surface 122a of the buffer chamber 122 and the second surface 123 conform to each other. Accordingly, the intersection portion 124 and the connection portion 125 are arranged at the same distance from the recording element substrate 106. In this example, the liquid cannot push the air bubbles against the connection portion 125 so that the connection portion 125 does not function as a separating portion configured to separate the air bubbles. Accordingly, there may arise problems in that the air bubbles reach the ejection orifices to cause the ejection failure, and that all of the air bubbles are discharged from the ejection orifices.

### Third Embodiment

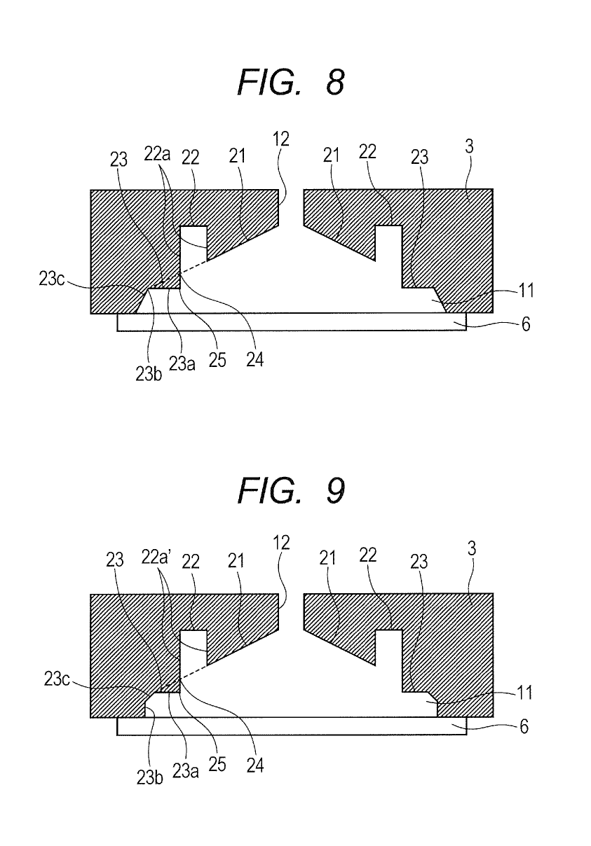

FIG. 8 is a view for illustrating an inkjet recording head 1 according to a third embodiment of the present invention. Similarly to FIG. 2, FIG. 8 is a sectional view of the inkjet recording head 1 of FIG. 1 taken along the line A-A.

As illustrated in FIG. 8, the third embodiment is different from the second embodiment in that the second portion of the second surface 23 is inclined so as to approach the recording element substrate 6 as extending away from the supply port 12 in the direction parallel to the recording element substrate 6.

Also in this embodiment, similarly to the first embodiment, the intersection portion 24 is more distant from the recording element substrate 6 than the connection portion 25. Thus, it is possible to prevent the ejection failure caused by the air bubbles. Further, a connection portion 23c between the first portion 23a and the second portion 23b of the second surface 23 is formed as an obtuse-angled corner portion. As a result, the air bubbles can be prevented from being accumulated in the vicinity of the connection portion 23c, and the air-bubble dischargeability can be enhanced.

FIG. 9 is a view for illustrating an inkjet recording head 1 according to a fourth embodiment of the present invention. Similarly to FIG. 2, FIG. 9 is a sectional view of the inkjet recording head 1 of FIG. 1 taken along the line A-A.

As illustrated in FIG. 9, the fourth embodiment is different from the second embodiment in that the connection portion 23c between the first portion 23a and the second portion 23b of the second surface 23 is inclined so as to approach the recording element substrate 6 as extending away from the supply port 12 in the direction parallel to the recording element substrate 6. Also in this embodiment, similarly to the first embodiment, the intersection portion 24 is more distant from the recording element substrate 6 than the connection portion 25. Thus, it is possible to prevent the ejection failure caused by the air bubbles. Further, the vicinity of an end portion of the liquid chamber 11 can be further widened. Thus, it is possible to enhance the ejection performance in the vicinity of the end portion of the liquid chamber 11 during ejection operation and recovery operation.

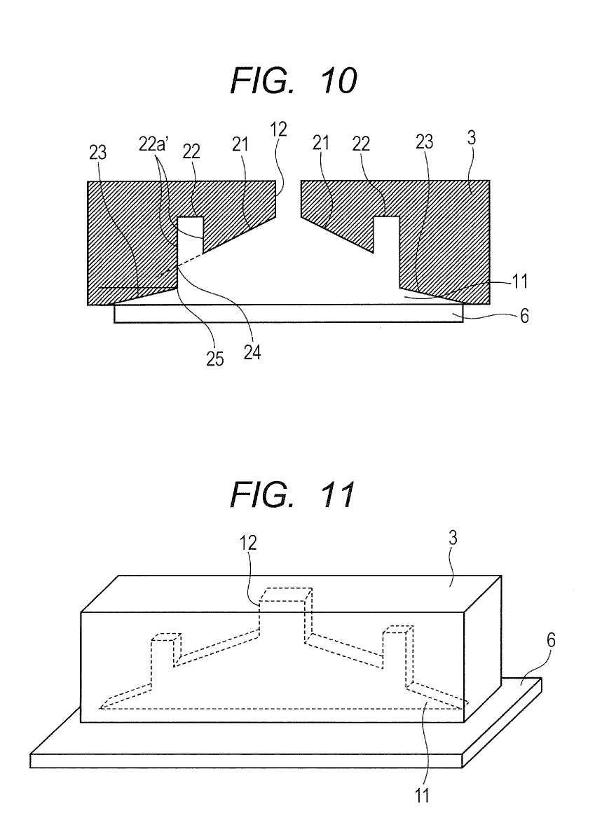

FIG. 10 is a view for illustrating the inkjet recording head 1 according to a fifth embodiment of the present invention. Similarly to FIG. 2, FIG. 10 is a sectional view of the inkjet recording head 1 of FIG. 1 taken along the line A-A.

As illustrated in FIG. 10, the fifth embodiment is different from the second embodiment in that the second surface 23 is entirely inclined so as to approach the recording element substrate 6 as extending away from the supply port 12 in the direction parallel to the recording element substrate 6.

Also in this embodiment, similarly to the first embodiment, the intersection portion 24 is more distant from the recording element substrate 6 than the connection portion 25. Thus, it is possible to prevent the ejection failure caused by the air bubbles. Further, a corner portion is not formed on the second surface 23. Thus, the air bubbles can be prevented from being accumulated.

In each embodiment, as illustrated in FIG. 11, the liquid chamber 11 is formed in the support member 3, and the supply port 12 is exposed from the support member 3. In FIG. 11, the support member 3 according to the fifth embodiment illustrated in FIG. 10 is exemplified, but the support member 3 according to other embodiments also has the same configuration.

Further, when the support member 3 of the inkjet recording head 1 described in each embodiment is made of a resin, the support member 3 can be formed by molding using a metal mold. Further, the support member 3 can be formed by pressing a powder material using a mold. In any case, the support member 3 does not have such a shape as to inhibit the support member 3 from being released from a mold. Accordingly, the support member 3 can be easily formed by the same method as the related-art method.

In each embodiment described above, the illustrated configuration is merely an example, and the present invention is not limited to the configuration.

According to the present invention, the intersection portion of the wall surface of the space chamber and the plane extended from the first surface is more distant from the recording element substrate than the connection portion between the wall surface of the space chamber and the second surface, thereby obtaining a configuration in which the connection portion protrudes toward the liquid chamber. Thus, of the liquid supplied from the supply port into the liquid chamber, a part of the liquid flowing along the first surface can push the air bubbles, which overflow from each of the space chambers, against the connection portion, to thereby separate the air bubbles. Therefore, the air bubbles can be prevented from becoming overly larger than necessary. As a result, it is possible to prevent the ejection failure caused by the air bubbles.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-146458, filed Jul. 24, 2015, which is hereby incorporated by reference herein in its entirety.

What is claimed is:

1. A liquid ejection head, comprising:
a liquid chamber configured to store liquid therein;
a supply port configured to supply the liquid into the liquid chamber; and
a recording element substrate, which is arranged at a position opposed to the supply port across the liquid chamber, and is configured to eject the liquid stored in the liquid chamber,
wherein the liquid chamber comprises:
a first surface connected to the supply port; and
a wall surface extending in a direction away from the recording element substrate,
wherein the wall surface comprises:
a space chamber connected to the first surface; and
a second surface connecting a wall surface of the space chamber and the recording element substrate to each other, and
wherein an intersection portion of the wall surface of the space chamber and a plane extended from the first surface is more distant from the recording element substrate than a connection portion between the wall surface of the space chamber and the second surface.

2. A liquid ejection head according to claim 1, wherein the wall surface of the space chamber is perpendicular to the recording element substrate.

3. A liquid ejection head according to claim 1, wherein the connection portion between the wall surface of the space chamber and the second surface is formed as a corner portion having an angle of 90°±5°.

4. A liquid ejection head according to claim 1, wherein the second surface comprises:
a first portion extending in parallel to the recording element substrate from the connection portion between the wall surface of the space chamber and the second surface; and
a second portion extending toward the first portion from a connection portion between the recording element substrate and the second surface.

5. A liquid ejection head according to claim 4, wherein the second portion is perpendicular to the recording element substrate.

6. A liquid ejection head according to claim 5, wherein a connection portion between the first portion and the second portion is inclined so as to approach the recording element substrate as extending away from the supply port in a direction parallel to the recording element substrate.

7. A liquid ejection head according to claim 1, wherein the second surface is inclined so as to approach the recording element substrate as extending away from the supply port in a direction parallel to the recording element substrate.

8. A liquid ejection head according to claim 1, wherein the first surface is parallel to the recording element substrate.

9. A liquid ejection head according to claim 1, wherein the first surface is inclined so as to approach the recording element substrate as extending away from the supply port in a direction parallel to the recording element substrate.

10. A liquid ejection head, comprising:
a recording element substrate having ejection orifices configured to eject liquid; and
a support member configured to support the recording element substrate,
wherein the support member comprises:
a liquid chamber configured to store therein the liquid to be supplied to the recording element substrate;
a supply port configured to supply the liquid into the liquid chamber;
a buffer chamber, which is formed in the liquid chamber on an opposite side to a side on which the recording element substrate is arranged, and is configured to accumulate air bubbles therein; and
a connection surface connecting the supply port and the buffer chamber to each other, and
wherein a plane extended from the connection surface intersects an inner wall surface of the buffer chamber.

11. A liquid ejection head according to claim 10,
wherein the inner wall surface of the buffer chamber comprises:
a first portion on the supply port side; and
a second portion on an opposite side to the first portion, and
wherein the plane extended from the connection surface intersects the second portion.

12. A liquid ejection head according to claim 10, wherein the connection surface extends along the recording element substrate.

13. A liquid ejection head according to claim 10, wherein the connection surface is inclined so as to approach the recording element substrate as extending away from the supply port.
